(19) United States
(12) Patent Application Publication
(10) Pub. No.: US 2005/0144439 A1
(43) Pub. Date: Jun. 30, 2005

(54) System and method of managing encryption key management system for mobile terminals

(76) Inventors: Nam Je Park, Daejeon-city (KR); Ki Young Moon, Daejeon-city (KR); Sung Won Sohn, Daejeon-city (KR); Chee Hang Park, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/940,090

(22) Filed: Sep. 13, 2004

(30) Foreign Application Priority Data
Dec. 26, 2003 (KR) 2003-97820

(51) Int. Cl. H04L 9/00

(52) U.S. Cl. 713/155

(57) ABSTRACT

An encryption key management method for mobile terminals for providing at least one mobile terminal which is connected to a network to use services with an encryption key required for issuing a certificate which is needed for the services and managed by a certification authority by using an encryption key management server is provided. The method includes operations of: a registration requesting operation where the mobile terminal generates an encryption key registration request; an encryption key managing operation where the encryption key management server generates and manages the encryption key in response to the encryption key registration request; a transferring operation of sending the generated encryption key to the mobile terminal; and a security service providing operation of receiving the certificate managed by the certification authority and providing selective security services specific to the content of the services provided to the mobile terminal. The method can relieve the hardware load of mobile terminals while providing a security service using various conventional certification authorities.

This application claims the benefit of Korean Patent Application No. 2003-97820, filed on Dec. 26, 2003, in the Korean Intellectual Property Office, the disclosure of which is incorporated herein in its entirety by reference.

### BACKGROUND OF THE INVENTION

1. Field of the Invention

The present invention relates to data encryption, and more particularly, to system and method of managing an encryption key which provide selective security services on data messages between wired/wireless terminals by using a wireless key management security unit based on the extensible markup language Key Management Specification (XKMS) coupled with a certification authority.

2. Description of the Related Art

As information technology advances, the use of wired and wireless internet has increased hugely, and services coupling wired and wireless internet services have become widespread. The extensible Markup Language (XML) based web services is becoming a global standard for internet and electronic business, and are one of the fundamentals for wireless mobile internet terminals to achieve unified wired/wireless services. However, such widespread use brings the need for effective security.

Security services on a network require encryption key management for protecting transmitted data, as well as bilateral authentication between users and servers. Various techniques of encryption key management have been introduced, and a method using public keys (“public key method”, hereinafter) by way of a certification authority is the most widely used of these.

The public key method performs security services using public and secret keys, and provides easier management of encryption keys than methods using only secret keys. In addition, the public key method can provide the security services required for a wireless internet service such as a non-repudiation service. However, the public keys used in the public key method must be authenticated, and a public key certificate issued by a certification authority is used to do this. Therefore, an operation for receiving the certificate from the public certification authority is needed. But in some cases, security services are provided using several different certification authorities in a global roaming situation, so a method for effectively authenticating and managing encryption keys which can be used in all situations is needed.

Wireless internet authentication and key management methods according to prior art include a method for providing security services between wired and wireless terminals using an extended header of a hypertext transmission protocol and a security script on a wireless internet application layer and a security script and a method providing a separate public key infrastructure adapted for a wireless atmosphere. The problem with using the public key infrastructure is that since the separate public key infrastructure is different from a conventional public key infrastructure using a conventional certification authority, the system cannot provide wireless internet functions and services in different wireless internet situations.

One solution to this problem is to use a public key infrastructure using the conventional wired certification authority, but it is not easy to implement a complex client processing authentication within the limitations of the wireless internet.

FIG. 1 is a block diagram of a conventional encryption key management system. The conventional encryption key management system includes mobile terminals as well as certification authorities. As shown in FIG. 1, mobile terminals receive a certificate for authenticating a secret key of their own from the certification authority. Therefore, the mobile terminal according to the prior art includes a module for communicating with the certification authority.

The conventional key management methods described above provide a common public service allowed in the public key infrastructure. In doing so, all data is encrypted and decrypted irrespective of the data contents, and selective security based on the contents is not possible. This is a serious problem, since resources are more limited in the wireless internet service than in the wired internet.

Therefore, a system and a method of encryption key management which relieve the hardware load of a mobile terminal while using the conventional certification authority are urgently required.

### SUMMARY OF THE INVENTION

It is an object of the present invention to provide an encryption key management system enabling selective security service on data messages between wired and wireless terminals using a wireless key management security unit on a wireless internet application layer.

It is another object of the present invention to provide a digital signature and encryption method for wireless key management systems which is applicable to a global standard.

It is still another object of the present invention to provide an encryption key management system including a XKMS-Signcryption processor which performs the XML digital signature and XML encryption at the same time to accelerate the XML digital signature and XML encryption of a wireless encryption key.

The present invention provides an encryption key management method for mobile terminals for providing at least one mobile terminal which is connected to a network to use services with an encryption key required for issuing a certificate which is needed for the services and managed by a certification authority by using an encryption key management server, the method comprising: a registration requesting operation where the mobile terminal generates an encryption key registration request; an encryption key managing operation where the encryption key management server generates and manages the encryption key in response to the encryption key registration request; a transferring operation of sending the generated encryption key to the mobile terminal; and a security service providing operation of receiving the certificate managed by the certification authority and providing selective security services specific to the content of the services provided to the mobile terminal. The a) registration requesting operation comprises: a1) transferring unique identification information of the mobile terminal and a Hashed Message Authentication Code (HMAC) from the mobile terminal to the encryption key management server, and the b) encryption key managing operation comprises: b1) when it is determined that the encryption key registration request from the mobile terminal is valid, generating and storing a public key and an encrypted secret key on the certification authority using the encryption key management server; and b2) when the public key and the encrypted secret key are successfully stored, informing the mobile terminal of the result using the encryption key management server.

The b) encryption key managing operation further comprises: b3) retrieving an encryption key corresponding to the mobile terminal in response to the encryption key registration request; b4) verifying the validity of the retrieved encryption key using the certification authority; b5) updating/discarding the encryption key according to a user selection when the encryption key is expired; and b6) restoring defective encryption keys. The non-linear algorithm uses an XML Key Management Specification (XKMS)-Signcryption technique, and the XKMS-Signcryption adopts one or more XML-based security techniques.

The present invention also provides an encryption key management system for mobile terminals comprising: at least one mobile terminal which is connected to a network to use services a certification authority managing a certificate needed for using the services; and an encryption key management server generating and managing the encryption key required for issuing the certificate according to a request from the mobile terminal, wherein the encryption key management server receives the certificate managed by the certification authority and provides-selective security services specific to the content of the services provided to the mobile terminal. The mobile terminal transfers unique identification information of the mobile terminal and a Hashed Message Authentication Code (HMAC) to the encryption key management server, and the encryption key managing server generates and stores the public key and the encrypted secret key on the certification authority and informs the mobile terminal of the result when it is determined that an encryption key registration request from the mobile terminal is valid.

The non-linear algorithm uses an XML Key Management Specification (XKMS)-Signcryption technique, and the XKMS-Signcryption adopts one or more XML-based security techniques.

The present invention can provide a security system to relieve the hardware load of mobile terminals while providing a security service using various conventional certification authorities.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an encryption key management system of the conventional art;

FIG. 2 is a block diagram of an encryption key management system including an encryption key management server according to the present invention;

FIG. 3 shows the operation of the encryption key management system in FIG. 2 in detail;

FIG. 4 shows the operation of the wired and wireless key management security unit and a certification authority processor in FIG. 3 in detail;

FIG. 5 schematically shows the operation of the encryption key management system according to the present invention;

FIG. 6 is a flowchart of an encryption key management method according to the present invention; and

FIG. 7 shows the order of operation of the encryption key management method of the present invention.

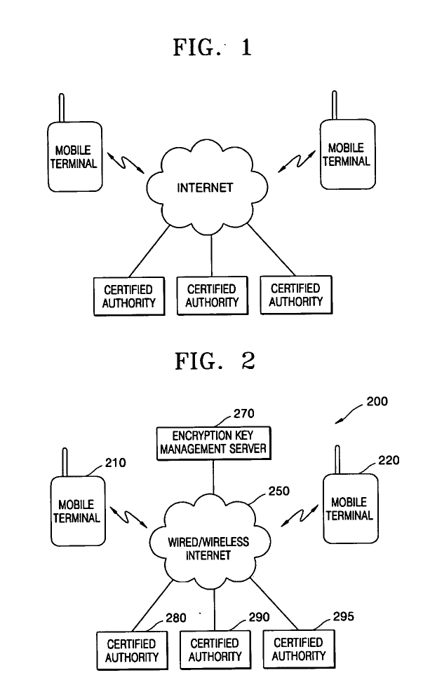

### SUMMARY OF REFERENCES

200: encryption key management system
210: web server daemon 250: wired/wireless internet
210: mobile terminal 310: wireless web browser
320: wireless key management security unit
330: web service application/security unit
340: wireless internet service interface
325: wired key management security unit
335: web service application/security unit
345: wired internet service interface
280,290,295: certification authorities
380: certification authority processor

### DETAILED DESCRIPTION OF THE INVENTION

FIG. 2 is a block diagram of an encryption key management system including an encryption key management server according to the present invention. In the encryption key management system of the present invention, mobile terminals 210 and 220, an encryption key management server 270, and certification authorities 280, 290, and 295 are connected by way of the wired/wireless internet 250. That is, the mobile terminals 210 and 220 in FIG. 2 provide selective security service based on data message contents by using the encryption key management server 270 connected to the certification authorities 280, 290, and 295 via the wired/wireless internet 250. As opposed to the encryption key management system of the prior art, it is the encryption key management server 270, not the mobile terminals 210 and 220, which generates and manages the encryption key. Therefore, it is easier to implement the encryption key management functionality in hardware and software than when implementing it in mobile terminals 210 and 220.

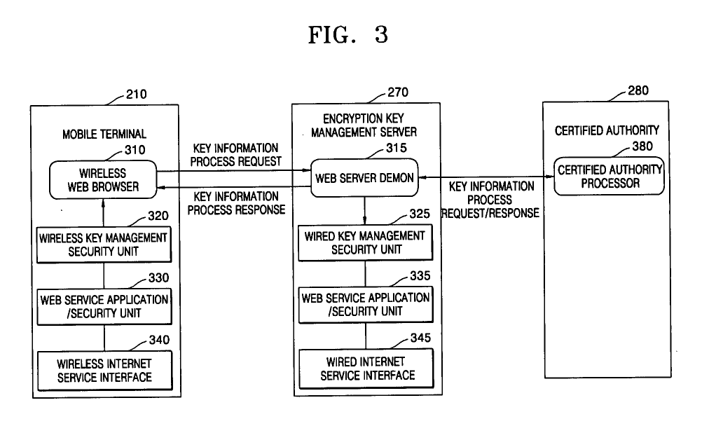

FIG. 3 shows the operation of the encryption key management system in FIG. 2 in detail.

The mobile terminal 210 in FIG. 3 includes a wireless web browser 310, a wireless key management security unit 320, a web service application/security unit 330, and a wireless internet service interface 340. The wireless key management security unit 320 requests encryption keys or receives a response to a key information process request from the encryption key management server 270. The wireless key management security unit 320 authenticates the validity of a digital signature of data messages and encrypts/decrypts the data message. The web service application/security unit 330 executes an application program for supporting wireless terminal web services and performs security operations. The wireless internet service interface 340 can provide a wireless XML interface needed for managing encryption keys.

The encryption key management server 270 processes encryption keys to authenticate and encrypt transmitted messages and the digital signature of documents. The encryption key management server 270 can be configured by XKMS which is a global standard, and includes a wired key management security unit 325 whose performance is same to that of the wireless key management security unit 320, a web service application/security unit 335, and a wired internet interface 350. The wired key management security unit of the encryption key management server 270 generates and registers keys with the certification authority according to a key registration request. Furthermore, the wired key management security unit 325 in the encryption key management server 270 performs key update/discard operations in response to a request for key management and process data messages of the mobile terminal 210. The web service application/security unit 335 in the encryption key management server 270 acts as an application processor and security processor for providing web services on the internet. The wired internet service interface 240 provides an XML interface needed for encryption key management.

And, the certification authority 280 manages the encryption key using the certification authority processor 380 based on the conventional standard certification protocol in response to the request from the encryption key management server 270.

The mobile terminal 210 uses internet services via internet to which it is wirelessly attached by using the wireless web browser 310. When the mobile terminal 210 attempts to use the security service, the wireless web browser 310 in the mobile terminal 210 request the web server daemon 315 in the encryption key management server 280 to process the key information. Then, the web server daemon 315 requests the certification authority processor 380 to process the key information, receives a response to the request, and returns the result to the wireless web browser 310 in the mobile terminal 210. As shown in FIG. 3, key generation and management operations are performed in the encryption key management server 270 and the certification authority 280, rather than in the mobile terminal 210, and therefore the mobile terminal 210 can use all services from various certification authorities 280.

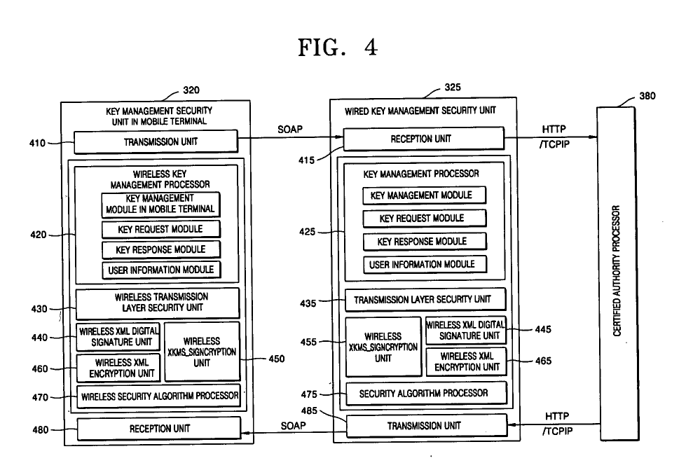

FIG. 4 shows the operation of the wired and wireless key management security unit and a certificate authority processor in FIG. 3 in detail. That is, FIG. 4 shows the configuration of the wireless key management security unit 320, the wireless key management security unit 325, and the certification authority processor 380 in detail. The wireless key management security unit 325 includes a transmission unit 410, a wireless key management processor 420, a wireless transmission layer security unit 430, a wireless XML digital signature unit 440, a wireless XKMS-Signcryption unit 450, a wireless XML encryption unit 460, a wireless security algorithm processor 470, and a reception unit 480. Correspondingly, the wired key management security unit 325 includes a reception unit 415, a wired key management processor 425, a transmission layer security unit 435, a wired XML digital signature unit 445, a wired XKMS-Signcryption unit 455, a wired XML encryption unit 465, a wired security algorithm processor 475, and a transmission unit 485. Furthermore, the wireless key management processor 420 and the wired key management processor 425 each have a key management module, a key request module, and a user information module.

The key management security units 320 and 325 perform digital signature and data encryption based on XML at the same time. In doing so, the key management security units 320 and 325 adopt the XKMS-Signcryption method using a hyperbolic curve to aid calculation (?). The schema defining the XKMS-Signcryption can be configured as a hybrid form of many XML security mechanisms. The key management security unit 320 in mobile terminals and the wired key management security unit 325 can be configured in software or hardware according to usage, and perform the functions of upper layer systems. In this case, the wireless key management security unit 320 and the wired key management security unit 325 can be connected using a simple object access protocol (SOAP) while the connection between the wired key management security unit 325 and the certification authority processor 380 can be established using HTTP or TCP/IP.

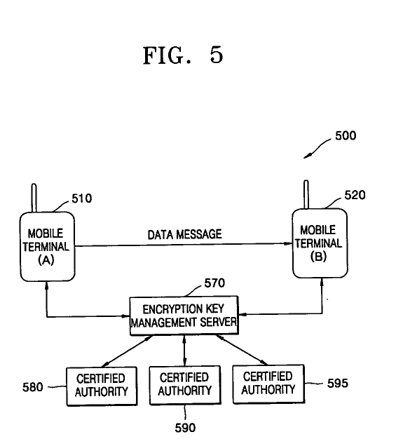

FIG. 5 schematically shows the operation of the encryption key management system according to the present invention.

In the encryption key management system shown in FIG. 5, mobile terminals 510 and 520 can be directly connected to each other, rather than connected to an encryption management server 570 via network. That is, the mobile terminals 510 and 520 shown in FIG. 5 can perform security functions only when they are connected to an encryption key management server. The operation of the elements shown in FIG. 5 except for the encryption management server 570 is similar or identical to that of the elements shown in FIG. 2, so detailed explanations are omitted for brevity.

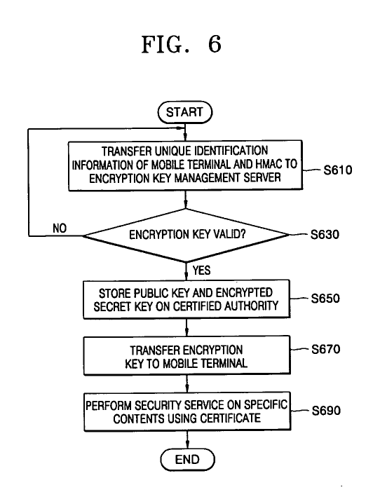

FIG. 6 is a flowchart of an encryption key management method according to the present invention.

At first, an encryption key management request is transmitted to an encryption key management server with unique identification information of mobile terminals and a Hashed Message Authentication Code (HMAC) in S610. Then, the encryption key management server determines whether the received encryption key management request is valid or not in S630. When it is determined that the encryption key management request is valid, a public key and an encrypted secret key are stored in a certification authority in S650. Then, the encryption key is transmitted to the mobile terminal in S670 to enable the mobile terminal to perform data encryption using the encryption key or to authenticate a digital signature by acquiring a certificate in S690.

In addition, it is preferable to perform the data encryption and the digital signature authentication at the same time.

The data message encryption operation using the encryption management system according to the present invention includes a key registration step, a step of retrieving the public key of a receiver and encrypting the data messages using a transmitter, a step of receiving and decrypting the message using the receiver, and when the encryption key information is not present on one certification authority, a step of retrieving the encryption key information from other certification authorities using the encryption key management system.

The digital signature operation on data messages using the encryption key management system also includes a step of registering a receiver's public key using the receiver, a step of transferring the signed data message to a sender, a step of verifying the digital signature with the public key using the receiver, and when the encryption key information is not present on one certification authority, a step of retrieving the encryption key information from other certification authorities using the encryption key management system.

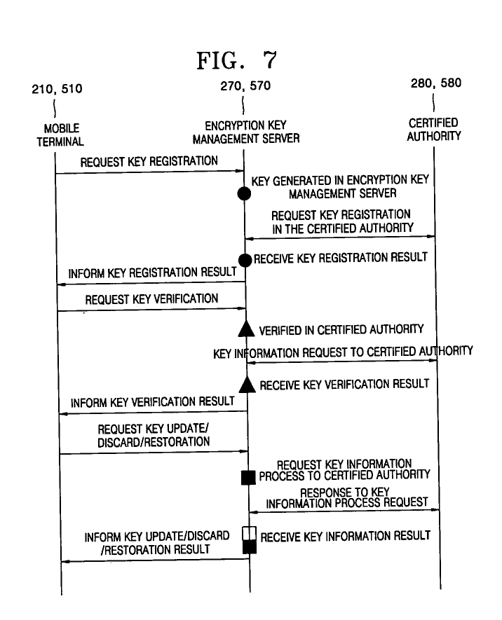

FIG. 7 shows order of operation of the encryption key management method of the present invention.

FIG. 7 shows in detail the sequential process of the encryption key management operation in an encryption key management server. The encryption key management operation includes a key registration request and response step for key management, a key verification request and response for key authentication, and a key update/discard/restoration step. Additionally, a key position request and response step (not shown) for retrieving key information is performed. Respective steps are described below in detail.
Key registration request and response step
a. A key registration request is transferred using the name of the mobile terminal and the HMAC from a program in mobile terminals 210 and 510 to encryption key management servers 270 and 570.
b. When the key registration request of the mobile terminals 210 and 510 is successfully received, encryption key management servers 270 and 570 generate a public key and an encrypted secret key and store them in certification authorities 280 and 580.
c. Encryption key management servers 270 and 570 receive the result of registration from certification authorities 280 and 580 and respond to the mobile terminals 210 and 510 with the result. In doing so, a secure transmission protocol is used.
key position request and response step
a. The program of mobile terminals 210 and 510 requests position information of the key from the encryption key management servers 270 and 570. In doing so, unique identification information of mobile terminals 210 and 510 is transferred to the encryption key management servers 270 and 570, and the identification information is mapped to a corresponding certificate including a public key or an authentication key.
b. The encryption key management servers 270 and 570 retrieve key information using the unique identification information received from the mobile terminals 210 and 510.
c. The encryption key management servers 270 and 570 receive the result of the request from certification authorities 280 and 580 and respond to the mobile terminals 210 and 510 with the result. In doing so, a secure transmission protocol is used.
key verification request and response step for key authentication
a. The program of mobile terminals 210 and 510 sends a request for key verification to encryption key management servers 270 and 570.
b. The encryption key management servers 270 and 570 verify the name of the mobile terminal and the public key referring to the certification authorities 280 and 580, retrieve the name and the public key and return the result.
c. The encryption key management servers 270 and 570 receive the result of the request from the certification authorities 280 and 580 and respond to the mobile terminals 210 and 510 with the result. In doing so, a secure transmission protocol is used.
key update/discard/restoration step
a. The program of mobile terminals 210 and 510 sends a request for key update/discard/restoration to encryption key management servers 270 and 570.
b. The encryption key management servers 270 and 570 forward the key update/discard/restoration request to the certification authorities 280 and 580 and respond to the mobile terminals 210 and 510 with the result. In doing so, a secure transmission protocol is used.

As shown in FIG. 7, the encryption key management system for mobile terminals based on web services according to the present invention is an encryption key management system based on XKMS coupling mobile terminals with PKI, and it is not only possible to use the functionality of the conventional PKI, but to restore lost encryption keys, since the encryption key is generated in server systems.

The embodiments of the present invention can be written as computer programs and can be implemented in general-use digital computers that execute the programs using a computer readable recording medium.

Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the internet).

The present invention provides an encryption key management system enabling selective security service on data messages between wired and wireless terminals using a wireless key management security unit on a wireless internet application layer.

The present invention also provides a digital signature and encryption method for a wireless key management system which is applicable to a global standard by applying an XML based digital signature and XML based encryption, on an encryption and digital signature processor in the wireless key management system.

The present invention also provides an encryption key management system including a XKMS-Signcryption processor which performs the XML digital signature and XML encryption at the same time to accelerate the XML digital signature and XML encryption of a wireless encryption key.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An encryption key management method for mobile terminals for providing at least one mobile terminal which is connected to a network to use services with an encryption key required for issuing a certificate which is needed for the services and managed by a certification authority by using an encryption key management server, the method comprising:
a) a registration requesting operation where the mobile terminal generates an encryption key registration request;
b) an encryption key managing operation where the encryption key management server generates and manages the encryption key in response to the encryption key registration request;
c) a transferring operation of sending the generated encryption key to the mobile terminal; and
d) a security service providing operation of receiving the certificate managed by the certification authority and providing selective security services specific to the content of the services provided to the mobile terminal.

2. The method of claim 1, wherein the a) registration requesting operation comprises:
a1) transferring unique identification information of the mobile terminal and a Hashed Message Authentication Code (HMAC) from the mobile terminal to the encryption key management server, and the b) encryption key managing operation comprises:
b1) when it is determined that the encryption key registration request from the mobile terminal is valid, generating and storing a public key and an encrypted secret key on the certification authority using the encryption key management server; and
b2) when the public key and the encrypted secret key are successfully stored, informing the mobile terminal of the result using the encryption key management server.

3. The method of claim 2, wherein the encryption key is generated using the unique identification information of the mobile terminal and the HMAC.

4. The method of claim 1, wherein the b) encryption key managing operation further comprises:
b3) retrieving an encryption key corresponding to the mobile terminal in response to the encryption key registration request;
b4) verifying the validity of the retrieved encryption key using the certification authority;
b5) updating/discarding the encryption key according to a user selection when the encryption key is expired; and
b6) restoring defective encryption keys.

5. The method of claim 1, wherein the method further comprises:
e) performing a digital signature and data encryption at the same time by using a predetermined non-linear algorithm based on extensible Markup Language (XML).

6. The method of claim 5, wherein the non-linear algorithm uses an XML Key Management Specification (XKMS)-Signcryption technique, and the XKMS-Signcryption adopts one or more XML-based security techniques.

7. The method of claim 5, wherein the e) performing a digital signature and data encryption operation comprises:
e1) a service subscriber registering the public key of the service subscriber on a predetermined certification authority;
e2) a service provider encrypting service content by reading the public key of the service subscriber;
e3) the service subscriber receiving and decrypting the service; and
e4) if information including the public key of the service subscriber is not present on the certification authority, then the encryption key management server retrieving the public key of the service subscriber from other certification authorities.

8. The method of claim 5, wherein the digital signature is performed by:
f1) the service subscriber registering the public key of the service subscriber on a predetermined certification authority;
f2) transferring a data message with a digital signature to the service subscriber;
f3) the service subscriber reading the public key and verifying the digital signature; and
f4) if information including the public key of the service subscriber is not present on the certification authority, then the encryption key management server retrieving the public key of the service subscriber from other certification authorities.

9. An encryption key management system for mobile terminals comprising:
at least one mobile terminal which is connected to a network to use services
a certification authority managing a certificate needed for using the services; and
an encryption key management server generating and managing the encryption key required for issuing the certificate according to a request from the mobile terminal, wherein the encryption key management server receives the certificate managed by the certification authority and provides selective security services specific to the content of the services provided to the mobile terminal.

10. The system of claim 9, wherein the mobile terminal transfers unique identification information of the mobile terminal and a Hashed Message Authentication Code (HMAC) to the encryption key management server, and the encryption key managing server generates and stores the public key and the encrypted secret key on the certification authority and informs the mobile terminal of the result when it is determined that an encryption key registration request from the mobile terminal is valid.

11. The system of claim 10, wherein the encryption key is generated using the unique identification information of the mobile terminal and the HMAC.

12. The system of claim 9, wherein the encryption key management server further comprises:
a module for retrieving an encryption key corresponding to the mobile terminal in response to the encryption key registration request;
a module for verifying the validity of the retrieved encryption key by using the certification authority;
a module for updating/discarding the encryption key according to a user selection when the encryption key is expired; and
a module for restoring defective encryption keys.

13. The system of claim 9, wherein mobile terminal performs a digital signature and data encryption at the same time by using a predetermined non-linear algorithm based on extensible Markup Language (XML).

14. The system of claim 13, wherein the non-linear algorithm uses an XML Key Management Specification (XKMS)-Signcryption technique, and the XKMS-Signcryption adopts one or more XML-based security techniques.

15. The system of claim 13, wherein the system comprises:
a storing module included in the certification authority for enabling the service subscriber to store the public key of the service subscriber registered by service subscriber;
an encrypting module which encrypts the service contents using the public key read by the service provider; and
a decrypting module which decrypts the service received by the service subscriber, and wherein if information including the public key of the service subscriber is not present on the certification authority, then the encryption key management server retrieves the public key of the service subscriber from other certification authorities.

16. The system of claim 13, wherein system comprises:
a storing module included in the certification authority for enabling the service subscriber to store the public key of the service subscriber registered by service subscriber;
a transferring module which transfers the data message with a digital signature to the service subscriber; and
a verifying module which verifies the digital signature by enabling the service subscriber to read the public key, and wherein if information including the public key of the service subscriber is not present on the certification authority, then the encryption key management server retrieves the public key of the service subscriber from other certification authorities.
